(19) United States
(12) Patent Application Publication
(10) Pub. No.: US 2017/0006694 A1
(43) Pub. Date: Jan. 5, 2017

(54) Wireless and Power Line Light Pairing, Dimming and Control

(71) Applicant: KORTEK INDUSTRIES PTY LTD, Southport, Queensland (AU)

(72) Inventors: Barrie Davis, Sanctuary Cove (AU); Benjamin Davis, Alderley (AU)

(21) Appl. No.: 15/125,579

(22) PCT Filed: Feb. 25, 2015
(86) PCT No.: PCT/AU2015/050077

§ 371 Date: Sep. 12, 2016

(30) Foreign Application Priority Data
Mar. 13, 2014 (AU) 2014900864

(51) Int. Cl. H05B 37/02; H04W 76/02; G08C 17/02; H05B 37/03

(52) U.S. Cl. CPC H05B 37/0272; H05B 37/03; H05B 37/0263; H04W 76/023; G08C 17/02; H04W 84/12

(57) ABSTRACT

A system and method for controlling a light in a residential or commercial location through a peer-to-peer wireless communications link with a personal controller. The system includes at least one lighting module (300a, 300b, 300c) and a system administrator device (200) having a wireless communications module (202) operable for wireless communications with the personal controller. The system administrator device also includes a local communications module (206) configured for power line communications with at least one of the lighting modules.

### FIELD OF THE INVENTION

The present invention relates to a system and method for authoring and controlling lights in domestic and commercial applications using a standard smartphone, tablet or similar item to act as a personal controller through a wireless peer-to-peer communications link and/or a wireless local area network.

### BACKGROUND OF INVENTION

Lighting is a common part of domestic and commercial buildings. Some structures have complex lighting automation systems that support the programming of parameters such as scheduling, dimming and color mixing. These typically operate through a number of wireless and hardwired technologies that use open or proprietary protocols through a combination of buttons, switches or remote controllers. While it is relatively easy to specify a lighting automation system during a building's construction, legacy systems are typically expensive; involve considerable additional wiring; and may not be compatible with emerging Light Emitting Diode (LED) luminaries. Conversely, a structure may be built with an absolute bare minimum of lighting control using standard hardwired light switches and nothing else. In this instance, the ability to introduce any additional form of lighting control or automation can be severely limited by the building construction and infrastructure making it impossible or expensive to add any new capabilities.

In recent years, the proliferation of smartphones has placed powerful computing devices in the hands of the public. While these devices can generate and transmit wireless control commands, their generic wireless systems are not compatible with the standards currently used in domestic or commercial lighting, so they cannot natively communicate with such in order to exchange data or control commands.

### SUMMARY

In one preferred embodiment, the present disclosure includes three parts: a system administrator with adaptable wireless and power line communication capabilities; a lighting module adapted to vary the power supplied to a lamp, luminaire or lighting element and exchange commands with a system administrator via power line communications; and a battery powered personal controller able to wirelessly communicate with a system administrator.

The system administrator is preferably configured to wirelessly operate: as an adaptable Wi-Fi Direct and network Wi-Fi device, either individually or concurrently, using Wi-Fi-Direct and/or network Wi-Fi technologies; and optionally as a Bluetooth device using Bluetooth SIG class 2.1+EDR or later technologies including Bluetooth Low Energy, Bluetooth 4.X and additional protocols such as CSRMesh. As used herein, “network Wi-Fi” refers to the Wi-Fi Alliance definition as any “wireless local area network (WLAN) products that are based on the Institute of Electrical and Electronic Engineers (IEEE) 802.11 standards” including any amendments, extensions or proprietary implementations. As used herein, the term “Wi-Fi Direct” refers to a device configured to support the Wi-Fi Alliance Wi-Fi Direct specification and amendments, extensions or any proprietary implementations of Wi-Fi peer-to-peer technology.

Wi-Fi Direct and Bluetooth are peer-to-peer capable communication technologies. Peer-to-peer communication methods and control aspects that may be incorporated into the system administrator are described in more detail in PCT Application No. PCT/AU2011/001666, filed Dec. 29, 2011, titled “Wireless Power, Light and Automation Control,” the entire disclosure of which is incorporated herein by reference. Network Wi-Fi is a communication technology that allows devices to communicate through a WLAN. Adaptable network, peer-to-peer communication methods and system attributes that may be incorporated into the system administrator are described in more detail in Australian Provisional Application No. 2013904180, filed Oct. 29, 2013, titled “Adaptable Multi-Mode Wireless Power, Light and Automation”, and PCT Application No. PCT/AU2012/000959, filed Aug. 15, 2012, titled “Adaptable Wireless Power, Light and Automation System” the entire disclosures of which are incorporated herein by reference.

The system administrator preferably includes a physical interface designed to accept mains level power and use the mains power wiring in a structure to exchange data with a lighting module. The system administrator and lighting module preferably communicate by way of power line communications and include the necessary hardware and capabilities for impressing a modulated carrier signal onto the mains power wiring. The supported power line communications may be by way of any protocol, standard or specification that facilitates communication between a system administrator and lighting module using mains power wiring. In one preferred embodiment, power line communications may incorporate one or more of: any HomePlug Powerline Appliance Homeplug standards or specifications; IEEE 1901, 1901.1 and/or 1901.2 standards or specifications; and/or ITU-T's G.hn standards or specifications; including any amendments, extensions, revisions or proprietary implementations. Other suitable protocols, standards or specifications may include, but are not limited to, those from the Universal Powerline Association, SiConnect, the HD-PLC Alliance, Xsilon and Powerline Intelligent Metering Evolution Alliance. Power line communication, control methods and system attributes that may be incorporated into the system administrator are described in more detail in PCT Application No. PCT/AU2013/001157, filed Oct. 8, 2013, titled “Wireless Power Control and Metrics”, the entire disclosure of which is incorporated herein by reference.

In one preferred embodiment, in addition to power line communications, the system administrator may preferably include the necessary hardware to support wireless communication with lighting modules via any combination of suitable personal area network (PAN) or home area network (HAN) wireless technologies, protocols, specifications, application profiles or standards including any ZigBee application profile, protocol, standard or specification published by the ZigBee Alliance; any protocol, specification or standard published by the WI-SUN Alliance; any protocol, specification or standard based on IEEE 802.15 including, but not limited to, IEEE 802.15.4; any Z-Wave protocol, specification or standard; any Thread protocol, specification or standard published by the Thread Group Alliance; and/or any protocol, specification or standard based on ANT including ANT+; including any amendments, extensions, revisions or proprietary implementations. Unless otherwise noted, the wireless local network communications capabilities will be described in terms of ZigBee, though the disclosure is not so limited. ZigBee methods and system attributes that may be incorporated into the system administrator are described in more detail in U.S. Application No. 61/786,519, filed Mar. 15, 2013, the entire disclosure of which is incorporated herein by reference.

In one preferred embodiment the system administrator may form part of a broader energy management system whose methods and system attributes are described in more detail in PCT Application No. PCT/AU2013/001157, filed Oct. 8, 2013.

The system administrator may include a physical power connector designed to accommodate a lighting module and supply the necessary power for the lighting module to run its control and communication systems for the purposes of authoring the lighting control module onto a power line communications or wireless ZigBee network.

The personal controller is preferably a commercially available mobile computing device that supports at least network Wi-Fi and may also support Wi-Fi Direct and/or Bluetooth and/or Near Field Communications (NFC). Unless otherwise noted, the personal controller will be described in terms of a smartphone, though the disclosure is not so limited. For example only, the personal controller may be any portable device which can download or install by other means an Applications Program (App), have a suitable interface the user can interact with to control the App in order to execute required functions, and have the wireless communications capability to establish communications with a system administrator. Examples of personal controllers include smartphones, tablets, laptops, ultrabooks, smart watches and notebook personal computers.

The lighting module is preferably configured to accept mains level or low voltage power, for the purpose of varying the power supplied to a lamp, luminaire or lighting element. The lighting module preferably utilizes a power line communications technology capable of creating a power line network with a system administrator and other lighting modules for the purpose of exchanging data with, and executing commands from, a system administrator. The lighting module preferably includes dimming capabilities and may also support color mixing through the manipulation of power to individual light generating elements where desired.

The system administrator can preferably form a communications link with a smartphone using Wi-Fi Direct and/or network Wi-Fi. It can be appreciated that when the system administrator is connected to a WLAN access point, any smartphone with Wi-Fi capability also connected to the same WLAN access point can use an appropriate App to communicate with the system administrator. That is, a user can enter a command into their smartphone and send it to the system administrator via the WLAN access point. In this case the smartphone could be in the vicinity of the WLAN access point, or the smartphone could be at a remote location and communicate with the WLAN access point via the Internet where the WLAN access point is so configured.

It can be appreciated that a system administrator operating in a Wi-Fi Direct mode can communicate peer-to-peer with a smartphone without the requirement of a WLAN access point. In this case, the system administrator preferably simulates a Wi-Fi access point, or operates as a software access point (SoftAP), if the smartphone is not using Wi-Fi Direct to communicate; or if the smartphone is using Wi-Fi Direct to communicate, the system administrator and smartphone can preferably negotiate which device will assume the Wi-Fi Direct group owner role and establish a peer-to-peer connection. Once a peer-to-peer connection has been established, the user is able to exchange data directly between a smartphone and the selected system administrator without the need for any other intermediary or network.

The present disclosure in one preferred embodiment provides a system administrator with wireless communication capabilities derived from any combination and number of integrated circuits, components, memory, microprocessors, aerials, radios, transceivers and controllers that provide both a network Wi-Fi and peer-to-peer Wi-Fi connection, or connections, individually or concurrently. In some preferred embodiments, the system administrator may also preferably include any combination and number of integrated circuits, components, controllers, transceivers, radios, memory, microprocessors, and aerials to support a wireless Bluetooth connection or connections. In some preferred embodiments, the system administrator may preferably include any combination of integrated circuits, components, controllers, transceivers, radios, memory, microprocessors, and aerials to support a wireless PAN or HAN utilizing one or more of ZigBee, Z-wave, ANT, Thread or an alternate wireless network communications protocol, specification or standard. In some preferred embodiments, the system administrator may preferably include any combination of integrated circuits, components, controllers, transceivers, radios, memory, microprocessors, and aerials to support communications of a wireless protocol, specification or standard on more than one carrier frequency, such as, and by way of example only, ZigBee operating simultaneously or selectively on a carrier frequency of 2.4 GHz and a chosen frequency under 1 GHz, or Wi-Fi operating simultaneously or selectively on a carrier frequency of 2.4 GHz and 5 GHz.

Depending on cost and desired outcome, the wireless communication capabilities of the system administrator may be achieved by using: any number and combination of discrete radios, aerials, microprocessors, transceivers, components, integrated circuits and controllers either individually, collectively, or as a system in a package (Si P) or as a system on a chip (SoC); a combination or “combo” chip that aggregates the functionality of a number of discrete transceivers and controllers of different standards as a SiP or SoC; or using a combination of combo chip/s, SiP/s, SoC/s and/or discrete components, integrated circuits, radios, aerials, transceivers, microprocessors and controllers. The system administrator may utilize single or multiple wireless bands, physical channels, virtual channels, modes or other coexistence technologies and algorithms, the methods of which are already known to those of ordinary skill in the art and are not described herein. Depending on the chosen hardware components, the system administrator may also include shared antenna support and shared signal receiving paths to eliminate the need for an external splitter or reduce the number of aerials required.

The present disclosure in one preferred embodiment provides a system administrator with adaptable wireless communications that in a first mode provides a peer-to-peer connection and in a second mode can be configured by the user to operate as a network Wi-Fi device and connect to a WLAN as a client.

The system administrator preferably has its wireless communications set to initially function in a peer-to-peer mode, preferably utilizing Wi-Fi Direct, irrespective of its final configuration. Because Wi-Fi Direct provides a peer-to-peer connection, as soon as power is applied to the system administrator, it can be recognised by a smartphone communicating with at least network Wi-Fi and a wireless communications link can be established. A smartphone App is preferably used to configure any operational aspects and control the functional capabilities of the system administrator. Once a wireless communication link is established, the user is able to activate a smartphone App which preferably uses the data path between the smartphone and system administrator. Using a smartphone App, the user can choose if the system administrator is to continue running in peer-to-peer mode, change to network Wi-Fi mode, or run both modes concurrently where supported, and set the system administrator with any operational parameters required for a network Wi-Fi or peer-to-peer device, name the device, set an encryption key, enter a password and any other requirements that may be required or desirable. When this procedure has been completed, the user can command the system administrator to “restart”, at which time it will configure itself according to the parameters which have been specified during the setup process.

If the user has chosen the system administrator to operate in a peer-to-peer mode, preferably utilizing Wi-Fi Direct, it would continue to do so after the restart. The system administrator would only connect to smartphones that can fully comply with its connection requirements before establishing a direct or peer-to-peer communications link. This may include security measures in addition to any native security measures of Wi-Fi Direct such as Wi-Fi Protected Access or Wi-Fi Protected Access 2.

If the user has chosen the system administrator to operate in network Wi-Fi mode, the smartphone App would configure the necessary parameters for the system administrator to connect to a WLAN. When the system administrator restarts, it would connect as a client device on the WLAN. It would then preferably be accessible to devices which are also connected to the same WLAN. A peer-to-peer wireless mode of the system administrator is preferably used to configure the necessary parameters for the system administrator to connect to a WLAN as a client.

In either mode, a smartphone App is preferably used control the functional capabilities of the system administrator. In network Wi-Fi mode, the smartphone App communicates with the selected system administrator via a WLAN access point. In a peer-to-peer mode preferably utilizing Wi-Fi Direct, the smartphone App communicates directly with the selected system administrator machine to machine.

If the user has chosen the system administrator to operate in both peer-to-peer mode and network Wi-Fi mode concurrently, when the system administrator restarts it would appear as a client device on the WLAN and as a Wi-Fi Direct access point/group participant with the functionality of each mode being available. In that way, and as an example only, a system administrator could allow third parties to control functions via a Wi-Fi Direct connection without allowing access to the concurrent WLAN connection, thus preventing access to other WLAN devices.

In one preferred embodiment, a Bluetooth peer-to-peer connection between a smartphone and system administrator may be used to enter information for configuration of the system administrator as a network Wi-Fi device and/or Wi-Fi Direct access point/group participant and/or peer-to-peer Wi-Fi device, or to facilitate the establishment of a network Wi-Fi and/or Wi-Fi Direct and/or peer-to-peer Wi-Fi connection. In another preferred embodiment, a Bluetooth connection between a system administrator and smartphone may be used as a peer-to-peer communication channel to exchange data.

Once a wireless communication link is established between a system administrator and smartphone, the user is able to activate an App which preferably uses the data path between the smartphone and system administrator to: join a power line communications network; configure any requirements for the system administrator to coordinate a power line communications network; or author devices onto the power line communications network. In addition to configuring the operational aspects of the system administrator, a smartphone App would also preferably be used to control and program various automation and interactive functions of lighting modules forming part of the power line communications network. In one preferred embodiment this could include the ability to set a specific scheduling of lighting events based on time parameters. In another preferred embodiment this could include specifying a colour hue from a graphical approximation displayed on the smartphone screen. In another preferred embodiment, this could include the ability to set a specific response in relation to a trigger event determined from a sensor connected to the power line network or a wireless network that system administrator is a part of.

The system administrator may have an exposed human interface such as a mechanical switch(s), button(s), or capacitive/proximity touch area(s). The lighting module may have an exposed human interface such as a mechanical switch(s), button(s), or capacitive/proximity touch area(s). In one preferred embodiment, it may be desirable to have no exposed human interface on either device.

The present disclosure in one preferred aspect provides a system for controlling the power supplied to lamps, luminaries or lighting elements in a domestic or commercial setting via lighting modules that can be controlled through a power line communications network by a standard smartphone, tablet or similar item acting as personal controller communicating through a wireless peer-to-peer communications link and/or a wireless local area network connection with a system administrator.

The present disclosure in another preferred aspect provides a system for controlling a light in a residential or commercial location through a wireless communications link with a personal controller, the personal controller having a processor, a user interface, and a wireless communications transceiver. The system includes at least one lighting module. The lighting module includes a microcontroller, a power line communications controller, and a power line connection operably connected to the power line communications controller, the lighting module being configured to vary power to a light connected to the lighting module. The system also includes a system administrator device including a microcontroller, a wireless communications module operable for wireless communication with the personal controller, and a local communications module configured for power line communications with the power line communications controller of the lighting module. The wireless communications module includes circuitry configured to communicate with the personal controller using a peer-to-peer communications link.

The present disclosure in a further preferred aspect provides for a method for controlling, with a personal controller, lighting at a residential or commercial location. The method includes: receiving, at a system administrator device at or near a lighting location, a command from the personal controller to vary power to at least one specified light at the lighting location, the command being received by the system administrator device using a wireless communications standard; sending a command, with the system administrator device, to at least one lighting module connected to the specified light to vary the power to the specified light, the command being sent by the system administrator device using a power line communications standard; and varying the power to the specified light, with the lighting module, in accordance with the command received from the system administrator device.

It will be understood that the claims as filed herewith are incorporated by reference in their entirety in the present description.

### BRIEF DESCRIPTION OF THE DRAWINGS

FIG. 1 is a perspective view of a smartphone in accordance with one preferred embodiment of the present disclosure.

FIG. 2 is a block diagram of the functional elements of a system administrator.

FIG. 3 is a block diagram of the functional elements of a lighting module.

FIG. 4 is a system pictorial representation of the smartphone of FIG. 1 and its interaction with the system administrator of FIG. 2 and lighting module of FIG. 3.

FIG. 5 is a flow diagram of an exemplary configuration procedure utilizing the smartphone of FIG. 1 to configure the system administrator of FIG. 2 as a client device in Wi-Fi WLAN of FIG. 4 in accordance with one preferred embodiment of the present disclosure.

### DETAILED DESCRIPTION OF THE DRAWINGS

Alternative embodiments of the disclosure will be apparent to those of ordinary skill in the art from consideration of the specification disclosed herein. It is intended that the specification and examples be considered as exemplary only, with a true scope and spirit of the invention being indicated by the claims which follow. It will be understood that the term “comprising” is intended to have a broad, open meaning and not limited to a particular embodiment.

Referring to FIGS. 1 to 4, system 100 preferably includes an applications program, hereby termed a “Product App,” a personal controller 10, a system administrator 200, and one or more lighting modules 300. It will be understood that when needed, the Product App is always used in combination with one or more processors, and where it is hosted, configures what might otherwise be a general purpose processor into a special purpose processor according to the functions and parameters of the Product App. The Product App may reside in a non-transitory medium such as the processor of a mobile communications device such as a smartphone, in a microprocessor of a system administrator, in a remote, offsite processor, or shared among devices or systems. Preferably, the Product App is downloaded to smartphone 10 and operates as a human interface for the control, configuration, programming and/or interrogation of system administrator 200, and through system administrator 200, the control, configuration, programming and/or interrogation of one or more associated lighting modules 300.

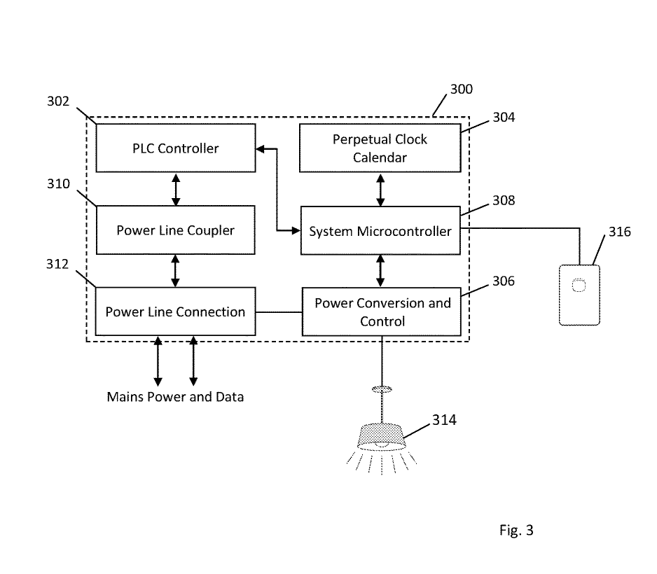

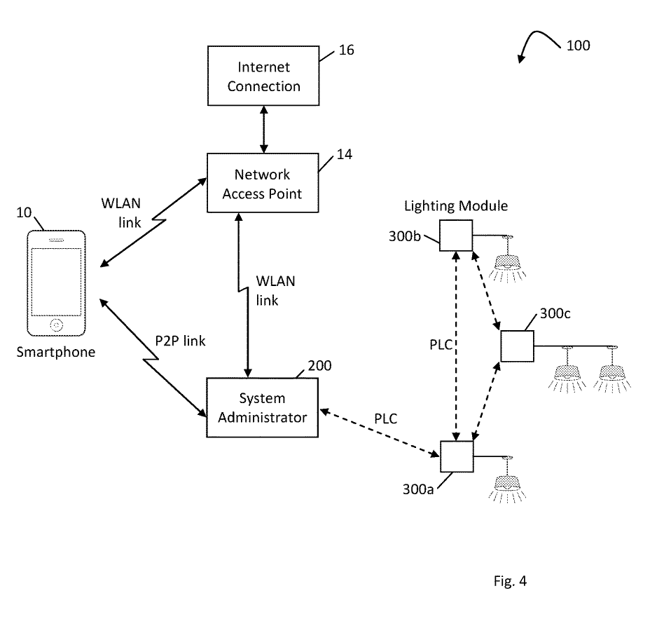

Each lighting module 300 is preferably adapted to vary power to an associated light, lamp, luminary and/or lighting element 314 (FIG. 3). Referring to FIG. 4, system 100 preferably utilises combined wireless communications and power line communications in order to facilitate the exchange of data and commands between smartphone 10, system administrator 200 and at least one lighting module 300. The communications between system administrator 200 and smartphone 10 preferably utilises a network WLAN or a wireless peer-to-peer connection. The communications between system administrator 200 and lighting modules 300 preferably uses power line communications (PLC) through a power line communications protocol. System administrator 200 preferably draws its operational power from the same mains power lines used to exchange data with lighting modules 300. The interaction of the Product App, smartphone 10, access administrator 200 and lighting modules 300 will be described in further detail below.

The multi-mode communication capabilities of system administrator 200 allow for a number of configurable communication topologies. By way of example, where system administrator 200 operates a network WLAN and peer-to-peer connection concurrently, system administrator 200 may allow third parties to control functions via the peer-to-peer connection without allowing access to the concurrent WLAN connection, thus preventing access to other WLAN devices. Alternately, system administrator may allow remote monitoring of the system or data exchange via the Internet through the network WLAN connection while limiting actual control of the system to a peer-to-peer connection.

FIG. 1 is a perspective representation of a smartphone 10 which uses a wireless link to communicate with a system administrator, described in further detail below. Smartphone 10 is preferably a commercially available, conventional smartphone. Some of the basic functions the smartphone preferably includes are: a touch sensitive graphical screen interface 12; a compatible radio transceiver; and the ability to run the Product App specific to the individual smartphone operating system. In the examples that follow, specific coding for the Product App has been omitted for simplicity as a person of ordinary skill in the art would be able to understand and reproduce the functionality of the described embodiments without the need for discussion on particular coding.

Smartphone 10 is preferably configured to operate across a range of wireless communications technologies, including the technology to communicate via at least network Wi-Fi. Smartphone 10 may include additional capability for Wi-Fi Direct and/or Bluetooth and/or NFC. While preferred embodiments of the present disclosure use a smartphone as its controller, and specifically a smartphone incorporating at least network Wi-Fi, other wireless communications methods and systems could be used depending on the specific requirements encountered.

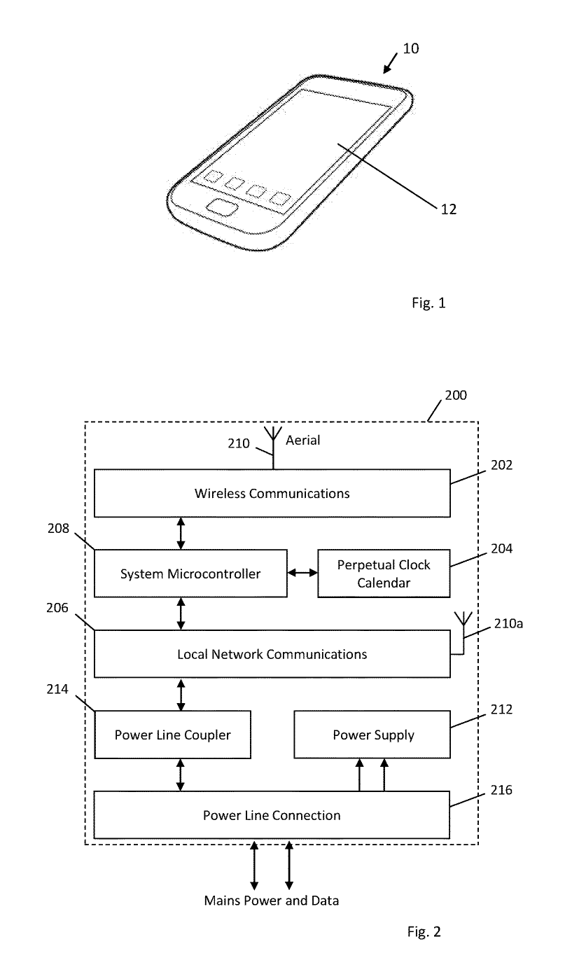

Referring now to FIG. 2, a system administrator 200 is shown in accordance with a preferred embodiment of the present disclosure. System administrator 200 is a physical device that preferably includes wireless communications module 202, perpetual clock calendar 204, local network communications module 206, system microcontroller 208 with embedded memory, an aerial 210, system power supply 212, power line coupler 214 and power line connection 216. Where local network communications module 206 includes support for wireless communications, it may preferably include a dedicated aerial 210a. In some preferred embodiments, it may be preferable for system microcontroller 208 to support external memory in addition to, or instead of, embedded memory. In some preferred embodiments, it may be preferable for system microcontroller 208 and local network communications 206 to be fully integrated, or for system microcontroller 208 and wireless communications 202 to be fully integrated. Wireless communications 202 includes the circuitry permitting system administrator to communicate with smartphone 10 and/or other system elements across one or more communications platforms, as will be described in further detail below.

Perpetual clock calendar 204 preferably includes a power backup by the way of a battery or super capacitor enabling real time to be accurately maintained in instances where power is lost. Inclusion of a perpetual clock calendar 204 allows system microcontroller 208 to automatically generate commands, perform a function, or exchange data based on schedules or a function of time and/or date. In some preferred embodiments, perpetual clock calendar 204 may be omitted where system administrator 200 does not perform any time or date dependant operations or receives clock data from an external source via power line or wireless communications. In some preferred embodiments, perpetual clock calendar 204 may be integrated into system microcontroller 208.

Power line connection 216 is preferably the physical interface for connecting system administrator 200 to the mains power wiring in a building. In one preferred embodiment, power line connection 216 is configured for compatibility with the NEMA 5-15 North American mains power standard allowing system administrator 200 to plug directly into a mains power general purpose outlet. In one preferred embodiment, system administrator 200 may take the physical form of a fully self-contained plug in pack or “wall wart”. In another preferred embodiment, system administrator 200 may have a flying lead. In another preferred embodiment, power line connection 216 may preferably incorporate a terminal block allowing system administrator 200 to be directly integrated into the electrical mains of a building or structure, or the electrical system of a vehicle or boat, and may be configured in a wall panel, or behind a wall mounted panel, or integrated into a general purpose power outlet or a light switch. It will be appreciated that access administrator 200 may be configured according to the wiring, connecting, mounting, plug and socket, and current and voltage requirements of various countries and applications without departing from the scope of the present disclosure.

While not shown, in one preferred embodiment system administrator 200 may offer an integrated power receptacle compatible with the power line connection of lighting module 300, allowing lighting modules to plug into and accept power from system administrator 200 in order for lighting module 300 to run its respective microprocessor and communications for the purpose of authoring a lighting module onto the power line or wireless networks of system administrator 200.

The commands and responses between system microcontroller 208 and smartphone 10 are preferably communicated through a radio frequency wireless link supported by wireless communications 202 and aerial 210. Wireless communications 202 preferably includes any number and combination of integrated circuits, components, controllers, transceivers, radios, memory, microprocessors, and aerials that provide a network Wi-Fi and Wi-Fi peer-to-peer connection individually or concurrently with the ability to optionally support Bluetooth. Examples of wireless communications are described in PCT Application No. PCT/AU2012/000959, filed Aug. 15, 2012. Depending on cost and the desired operational functions, wireless communications 202 may include a Wi-Fi radio, a combination of Wi-Fi radios, or a combination of Wi-Fi Radio(s), wireless radio(s) and a Bluetooth radio. The wireless communication capabilities may be achieved by using any number and combination of radios, aerials, transceivers, microprocessors, components, integrated circuits and controllers either individually, collectively, or as a system in a package (SiP) or as a system on a chip (SoC); a combination or “combo” chip that aggregates the functionality of a number of transceivers and controllers of different standards as a SiP or SoC; or using any combination of combo chip(s), SiP(s), SoC(s) and/or discrete integrated circuits, radios, aerials, transceivers, microprocessors, memory, components and controllers. Wireless communications may utilize single or multiple wireless bands, physical channels, virtual channels, modes or other coexistence technologies and algorithms, the methods of which are already known to those skilled in the art and are not described herein. Depending on the chosen hardware components, wireless communications 202 may also include shared antenna support and shared signal receiving paths to eliminate the need for an external splitter or reduce the number of aerials required. If desired, an additional aerial or aerials may be added where shared antenna support is not feasible. In one preferred embodiment, wireless communications 202 may be configured to support ZigBee. If desired, an additional aerial or aerials may be added where shared antenna support is not feasible.

When wireless communications 202 operates using a peer-to-peer Wi-Fi specification or standard, preferably Wi-Fi Direct, it can communicate with devices that support network Wi-Fi or Wi-Fi Direct on a peer-to-peer basis without the need for any intermediary hardware. Wireless communications 202 is preferably configured to operate according to the Wi-Fi Direct specification as both a Wi-Fi Direct group participant and Wi-Fi Direct access point or SoftAP, allowing access administrator 200 to appear to devices communicating with network Wi-Fi as a Wi-Fi access point. Through a SoftAP, wireless communications 202 is able to establish a peer-to-peer communications link with a network Wi-Fi device even though the network Wi-Fi device many not support Wi-Fi Direct. In this instance, a device using network Wi-Fi to communicate will receive a device discovery message from system administrator 200 as if from a Wi-Fi access point and be able to establish a peer-to-peer communications link with the system administrator as though it were connecting to a Wi-Fi access point. The procedure of establishing a communications link between a Wi-Fi Direct device and network Wi-Fi devices are defined in the Wi-Fi Alliance Wi-Fi Direct specifications and would be understood by practitioners skilled in communications systems protocols.

Wi-Fi Direct has a number of advantages which simplify communications between a system administrator and a smartphone operating as a controller. Significant advantages include mobility and portability, where a smartphone and system administrator only need to be within radio range of each other to establish a wireless communications link. Wi-Fi Direct offers secure communications through means such as Wi-Fi Protected Access (WPA, WPA2) and encryption for transported messages, ensuring the system remains secure to qualified devices. Most importantly, Wi-Fi Direct allows a smartphone with only network Wi-Fi to engage in peer-to-peer data exchange with a system administrator even where the smartphone network Wi-Fi was never intended to support on-demand, peer-to-peer communications.

As smartphones continue to evolve, new models are starting to include Wi-Fi Direct support in addition to network Wi-Fi. In one preferred embodiment of the present disclosure, where a system administrator 200 and smartphone 10 exchange a Wi-Fi Direct intent as part of the discovery process, the smartphone 10 and system administrator 200 will negotiate which device assumes the role of group owner in accordance with the Wi-Fi Alliance Wi-Fi Direct specification, and a peer-to-peer Wi-Fi Direct communication link will be established. The Wi-Fi Direct specification allows any Wi-Fi Direct device to be a group owner, and depending on the capabilities of the device, the negotiation procedure determines the most suitable device to perform this role. System administrator 200 in one preferred embodiment may preferably be configured at the highest priority to negotiate a Wi-Fi Direct connection as group owner. By operating as group owner, system administrator 200 can maintain a number of simultaneous peer-to-peer connections in what is commonly referred to as a hub and spoke arrangement, although it may be desirable in some circumstances to limit the number of open connections to 1:1.

System microcontroller 208 preferably incorporates a firmware program which defines the operation and functions of system administrator 200 and assumes responsibility for controlling all program code and system elements, including: specifying and controlling the operational modes of wireless communications 202; control and interrogation of perpetual clock calendar 204; control and management of local network communications 206; and facilitating the exchange of data and control messages between the Product App and a lighting module via wireless communications 202 and local network communications 206. System microcontroller 208 preferably includes non-volatile memory to store any program data received from the Product App. In some preferred embodiments, the non-volatile memory may be external to system microcontroller 208. In some preferred embodiments, more than one microcontroller may be used.

When system administrator 200 is manufactured, system microcontroller 208 preferably holds the firmware to operate system administrator 200 as a network Wi-Fi device and Wi-Fi Direct access point/group participant. When power is applied to system administrator 200 for the first time, system microcontroller 208 preferably starts wireless communications and control module 202 in Wi-Fi Direct peer-to-peer mode and begins transmitting discovery messages that can be detected by a smartphone within wireless range.

It can be appreciated that a system administrator operating as a Wi-Fi Direct access point/group participant can communicate directly with a smartphone without needing a Wi-Fi WLAN. System administrator 200 preferably appears as a Wi-Fi access point if smartphone 10 is not using Wi-Fi Direct to communicate; or negotiates with smartphone 10 as to which device will assume a Wi-Fi Direct group owner role if smartphone 10 is using Wi-Fi Direct to communicate. The user is then able to establish a peer-to-peer communications link and send commands directly to the selected system administrator without the need for any other device.

In one preferred embodiment, wireless communications 202 in a peer-to-peer mode may be configured to preferably simulate a Wi-Fi access point or operate as a SoftAP without support for Wi-Fi Direct. In that case, a smartphone would preferably establish a peer-to-peer communications link with the system administrator as if connecting to a Wi-Fi access point, but could not negotiate with the system administrator a Wi-Fi Direct connection even if smartphone 10 supported Wi-Fi Direct.

A preferred method for controlling a system administrator is through a related Product App. Installation instructions for the Product App are preferably included with the system administrator. The Product App preferably adopts the same centralized app store installation methods commonly utilised by conventional smartphone platforms.

The Product App may communicate with any mix of wireless elements and radio technologies that seamlessly provide the best communications link with a system administrator. The Product App preferably controls smartphone 10 wireless communications in order to initiate, search and establish a wireless communications link with a system administrator. The Product App may preferably display preconfigured and new system administrators via graphical elements on smartphone touch screen 12.

When the Product App starts, it will preferably scan for system administrators and identify any new system administrator that needs to be initially configured. At this point, if a wireless peer-to-peer connection has not already been established between the smartphone and a new system administrator, the Product App preferably allows the user to establish a wireless peer-to-peer connection with the desired system administrator and determine if it is: to operate in peer-to-peer mode and remain a Wi-Fi Direct access point/group participant only; to operate in network Wi-Fi mode and connect to a WLAN as a client and become a network Wi-Fi device; or, where supported by wireless communications 202, operate concurrently in peer-to-peer mode and network Wi-Fi mode.

In a situation where the smartphone operating system does not allow the Product App to control the smartphone wireless communications in order to establish a peer-to-peer link with a system administrator, the user may use any mechanism provided by the smartphone to establish a peer-to-peer communication link with a system administrator prior to starting the Product App.

If the user wants the new system administrator to run in a peer-to-peer mode, preferably utilizing Wi-Fi Direct, they preferably select this option in the Product App. The Product App then leads the user through a series of data inputs using the smartphone's touch screen 12 as a human interface. The Product App communicates with system microcontroller 208 and replaces the general parameters used for the initial connection to specific parameters which define the system administrator as a unique product. These may include: setting a unique encryption key so all data transfers between the system administrator and the smartphone are protected; setting the system administrator name to a unique, easily recognisable identifier; and setting a password in the system administrator used to establish a secure link with a smartphone.

The Product App preferably maintains a record of these specific parameters in the smartphone memory for future identification of, and connection to, the configured system administrator.

Once the setup procedure is complete, the Product App preferably commands the system administrator firmware to reconfigure which may involve a “restart”. When the applications firmware reconfigures, the system administrator will use the user specified data to populate and create its own unique identity. The smartphone which was used to set this identity will be able to automatically connect to that system administrator because the new specific parameters are known. Where the smartphone operating system allows, the Product App can then be used to preferably automatically establish a communications link with the system administrator each time the user selects that particular device in the Product App.

Once a system administrator has been configured, any other smartphone can only connect with it if the user knows the specific parameters that are now unique to that particular system administrator. If a second smartphone searches for Wi-Fi access points or Wi-Fi Direct devices, it will see the configured system administrator with the characteristic that it is “secure”. To connect to it, the user will have to know the specific password allocated to that system administrator, otherwise it will not be able to establish a communications link. If the password is known and entered into the smartphone when requested, a communication link between the second smartphone and the system administrator will be established. The Product App is still preferably required to control the system administrator and this may have additional security measures depending on the nature of the application.

If, instead of configuring the newly installed system administrator in peer-to-peer mode, the user chooses it to operate in network Wi-Fi mode, this is selected as the required option and the Product App determines if there are one or more WLANs available for the system administrator to connect to as a client. The Product App requests the user to confirm the preferred network and asks the user to confirm and/or input any necessary network parameters such as the network password so the system administrator can connect to the WLAN as a client.

The Product App, via the smartphone, communicates with system microcontroller 208 and sets the parameters needed for the system administrator to establish itself as a network Wi-Fi device which may include any parameters that uniquely identify the system administrator on the network. When all of the appropriate parameters are known and updated, the Product App commands the system administrator to restart as a network Wi-Fi device. The system administrator then connects to the WLAN as a client and is accessible by the smartphone Product App via the WLAN access point. The system administrator running as a network Wi-Fi client can then be controlled by other smartphones on the same WLAN. In one preferred embodiment, it may be desirable for the system administrator to include additional security measures such as password protection, a socket layer with the Product App, a hardware authorization chip, or other measures to prevent the system administrator being controlled by other devices on the network without authorization.

Preferably, where the smartphone is configured to determine from a system administrator's wireless signal that the system administrator is a new wireless device that can be configured as a WLAN network client, the smartphone preferably allows a user to automatically input the necessary network parameters of a known WLAN network from the smartphone's memory into the system administrator wirelessly using a peer-to-peer communications link to automatically configure the system administrator as a network client of the known WLAN network. The smartphone may also preferably be able to determine from the system administrator's wireless signal a product identifier allowing the smartphone to automatically download the system administrator's related Product App from the appropriate App store.

Once a system administrator has been configured as a peer-to-peer device or a network Wi-Fi device, it preferably continues to operate in that mode even after it has been powered off and then on again. All of the specific operating parameters for each mode are preferably saved in the non-volatile memory and are retained if power is removed. When power is restored, system microcontroller 208 powers up in the same Wi-Fi mode that was running before power was removed, and the appropriate firmware and operating parameters are restored from non-volatile memory.

There are applications where a system administrator running concurrent peer-to-peer mode and network Wi-Fi mode is desirable. In this situation, the user via the Product App may preferably activate both modes, allowing either mode to be used. Equally, the user, via the Product App, can choose to disable one of the modes, or can change from peer-to-peer mode to network Wi-Fi mode, or vice versa, as desired.

Each time the Wi-Fi mode is changed, the parameters for the new mode are preferably retained by system microcontroller 208 in the event power is disconnected or lost. When power is restored, system microcontroller 208 powers up in the same Wi-Fi mode as previously operating before power was removed, and the appropriate operating parameters are restored from the non-volatile memory. Thus, system microcontroller 208 preferably is configured with an adapted default setting that can be restored from the non-volatile memory.

It is envisaged that there may be times when a system administrator may need to be completely reset. The Product App is preferably able to communicate with the system administrator and command it to re-initialise to the factory default configuration. In this case, all user-defined parameters that were loaded into the system administrator unit are lost and it is returned to its factory default state, ready to receive new user-defined parameters.

The system administrator may incorporate a human interface in the form of a switch(s), button(s), or a capacitive/proximity touch pad(s), which the user could use to cause the access administrator to: re-initialise to the factory default configuration without the use of a smartphone or Product App; reboot the system; or assist in a Wi-Fi Protected Setup. If desired, the system administrator may be configured for operation without any manual inputs on the device itself.

In one preferred embodiment, wireless communications 202 may include Bluetooth communication capabilities in addition to Wi-Fi Direct and network Wi-Fi capabilities. Referring to FIG. 4, a peer-to-peer Bluetooth communication link between smartphone 10 and system administrator 200 may be used by the Product App to enter parameters for establishing a Wi-Fi Direct or network Wi-Fi communications link, or open a Wi-Fi Direct or network Wi-Fi communications link, or may in its own right operate as a peer-to-peer communications link for exchange of data between the Product App and system administrator 200. The Product App, the smartphone operating system, or a human interface on system administrator 200 in the form of touch pad(s), button(s) or switch(s), may facilitate the establishment of a Bluetooth peer-to-peer connection between system administrator 200 and smartphone 10. The Product App may be configured to allow a user to specify Bluetooth as the preferred peer-to-peer communication method between a system administrator 200 and smartphone 10. The Bluetooth connection preferably utilizes the secure transmission methods and protocols native to the chosen Bluetooth standard.

Where smartphone 10 and system administrator 200 use a proprietary implementation of peer-to-peer Wi-Fi, or an adaptation of Wi-Fi Direct, system administrator 200 and smartphone 10 are preferably configured to use the handshake, negotiation methods, protocols, specifications, standards and configuration requirements particular to that proprietary implementation of peer-to-peer Wi-Fi or adaptation of Wi-Fi Direct and may incorporate any hardware, software, firmware or authentication schemes necessary, and may use Bluetooth to facilitate the process where supported.

In one embodiment, a communications link or mode utilising an ad-hoc IBSS mode of IEEE802.11 (as commonly understood by those of ordinary skill in the art) is hereby expressly excluded.

In one preferred embodiment, the system administrator may include NFC capability that the Product App could use when first communicating with a new system administrator to automatically establish a network Wi-Fi, Wi-Fi Direct, Bluetooth or other peer-to-peer communications link on smartphones that support NFC. This process is commonly referred to as “bootstrapping” and is an established method for initializing communications known by those skilled in the art.

Referring back to FIG. 2, local network communications 206 preferably includes any combination of integrated circuits, components, controllers, digital signal processors, transceivers, memory, microprocessors, SiPs, or SoCs that allow system microcontroller 208 to communicate with lighting module 300 preferably through the mains wiring of a building using a power line communication protocol, specification or standard. In one preferred embodiment, power line communications may be implemented using a single chip solution with integrated random access memory (RAM), physical layer (PHY), medium access controller (MAC), and analog front end. Local network communications 206 preferably supports one or more of: the HomePlug Powerline Appliance Homeplug standards or specifications including HomePlug Green PHY or Homeplug AV2; IEEE 1901, 1901.1, 1901.2 standards or specifications; and/or ITU-T's G.hn standards or specifications; including any amendments, extensions, subsets, revisions or proprietary implementations. Other suitable protocols, standards or specifications include, but are not limited to, those from the Universal Powerline Association, SiConnect, the HD-PLC Alliance, Xsilon, and the Powerline Intelligent Metering Evolution Alliance.

In one preferred embodiment, in addition to power line communications, local network communications 206 may preferably include any combination of integrated circuits, radios, aerials, memory, microcontrollers, SiPs, SoCs, transceivers, components or controllers that allow system administrator 200 to wirelessly communicate with a lighting module via any suitable wireless PAN or HAN mesh standard, protocol or specification including one or more of: any ZigBee protocol, specification, application profile or standard published by the ZigBee Alliance; any ANT protocol, specification or standard; any protocol, specification or standard published by the WI-SUN Alliance; any Z-Wave protocol, specification or standard; any Thread protocol, specification or standard published by the Thread Group Alliance; or any protocol, specification or standard based on IEEE 802.15 including, but not limited to, IEEE 802.15.4; including any amendments, extensions, subsets, revisions or proprietary implementations. Where local network communications 206 includes support for wireless communications, aerial 210a, or aerials, may be added as required. Where local network communications 206 includes support for both power line communications and a wireless mesh standard, system microcontroller 208 or a dedicated microcontroller in local network communications 206 may communicate using the power line network or wireless mesh network simultaneously, or dynamically assess the most robust communication channel with lighting module 300 and use the most robust communication medium in forming a communications link or transferring data down an open communication link. It can be appreciated that some lighting modules may be installed with only ZigBee wireless communication capabilities. Preferably, system administrator 200 is configured with both ZigBee wireless and power line communications, but only operates using ZigBee wireless with those lighting modules units that only support ZigBee.

Because power line communications can travel outside a user's building via the mains power wiring, system administrator 200 preferably supports encryption for communications with lighting module 300. Access administrator 200 and electricity lighting module 300 preferably adopt the standards and/or specifications for security and encryption of data including any passwords, security keys or other secure linking methods that are native to the chosen power line communication protocol, specification, or standard.

In one preferred embodiment, and without limiting the ability to use any other pairing techniques of a particular power line communications protocol, specification or standard, where system administrator 200 and lighting module 300 communicate using a HomePlug Powerline protocol, specification, or standard, lighting module 300 may preferably ship as an un-associated station and go into a power-on network discovery procedure broadcasting an un-associated identifier message and determining if a Homeplug network is active and can be joined on the mains power wiring of a building.

In order for lighting module 300 to join system administrator's 200 secure power line network, lighting module 300 preferably first obtains the network membership key of system administrator 200. In order to obtain the network membership key, the lighting module is preferably programmed with a unique device access key. Using the wireless communication link between smartphone 10 and system administrator 200, the user via the Product App preferably enters the unique device access key of lighting module 300 into system administrator 200. System administrator 200 uses the device access key to encrypt its network membership key and broadcast this over the power line network. Since the device access key is unique to lighting module 300, it will be the only new station capable of decrypting the broadcast message from system administrator 200 in order to retrieve the network membership key. Once the lighting module retrieves the network membership key, it can use this to join the power line network of system administrator 200. At that point, system administrator 200 preferably shares with lighting module 300 a network encryption key ensuring all communication between system administrator 200 and lighting module 300 are encrypted and secure.

The device access key of lighting module 300 may be recorded on the physical unit, or in paperwork or an electronic format associated with the lighting module. The device access key may be recorded in a visually readable from, such as QR code or barcode, allowing the Product App to utilize the smartphone camera to scan and automatically populate the Product App with the device access key. It can be appreciated that a visually readable code may also contain additional information about the functional capability of lighting module 300, allowing the Product App to automatically associate and expose relevant controls for the functional capabilities of the lighting module during configuration. By way of example only, functional capabilities may include the lighting module's ability to support color mixing in an attached lamp, luminaire, or lighting element, or vary the brightness of an attached lamp, luminaire, or lighting element through a dimming circuit. In one preferred embodiment, instead of, or in addition to a visually readable code, lighting module 300 may be configured with an NFC capability allowing for the transfer of the device access key and any additional information to the Product App using near field communications where supported by the smartphone. The device access key may be manually entered into the Product App.

Lighting module 300 and system administrator 200 may be provided together as a matched set or kit with all networking requirements already preconfigured. For example, system administrator's networking membership key and any other necessary networking requirements may be entered by the vendor or manufacturer into lighting module 300, thereby pre-configuring lighting module 300 as an associated station of system administrator 200 and therefore able to establish a secure power line network as soon as being powered on.

It can be appreciated that other methods of authoring a lighting module onto the system administrator's power line network can be used without departing from the scope of the present disclosure, including methods that may use a human interface such as software or hardware buttons. By way of example only, an asymmetric public/private key encryption method could be utilized by pressing a software button in the Product App and a hardware button on the lighting module, the methods of which would be understood by those of ordinary skill in the art. If desired, system administrator 200 may include a button, switch or touch pad that could be used to put system administrator 200 into a secure pairing mode for the purpose of establishing a secure communications link with a lighting module 300. If desired, lighting module 300 may include a human interface such as a button, switch or touch pad that could be used to put lighting module 300 into a secure pairing mode for the purpose of establishing a secure communications link with system administrator 200.

A secure network between system administrator 200 and lighting module 300 may be limited to system administrator and lighting modules if desired, thereby forming a private secure network. A software, firmware or hardware layer in system administrator 200 and lighting module 300 may be included to provide an additional security service preventing other devices from communicating with the system administrator or lighting modules even if on the same physical layer using the same network membership key or security credentials.

Referring to FIG. 2, data is physically modulated onto the mains wiring preferably through power line coupler 214 which preferably includes any necessary isolation or filters.

System administrator 200 may be configured to include one or more illumination means or visual elements that represent a status or operative element of system administrator 200. A visual element could be by way of simple light emitting diodes, LCD, colour LCD, an integrated display, or any combination thereof.

It will be appreciated by those of ordinary skill in the art that the system described above can be varied in many ways without departing from the scope of the present disclosure. By way of example only, elements of wireless communications module 202, system microcontroller 208, perpetual clock calendar 204 and local network communications module 206 may be aggregated or separated into single components, SoCs or SiPs. For example only, wireless mesh communications such as ZigBee may be added to wireless communications 202 instead of local network communications 206. If desired, power line communications and ZigBee wireless communications may be aggregated into a single SoC or SiP. Where wireless communications 202 is configured to support a wireless mesh network, an additional aerial or aerials may be added where shared antenna support is not feasible.

FIG. 3 shows the preferred functional elements of lighting module 300. Lighting module 300 preferably includes power line communications controller 302, perpetual clock calendar 304, power conversion and control 306, system microcontroller 308 with an embedded memory, power line coupler 310 and power line connection 312. In some preferred embodiments, it may be preferable for system microcontroller 308 to support external memory in addition to, or instead of, embedded memory. In some preferred embodiments, system microcontroller 308 and power line communications controller 302 may be fully integrated or aggregated. In some preferred embodiments, perpetual clock calendar may be omitted entirely, or form part of system microcontroller 308.

Power line connection 312 is the physical interface for connecting lighting module 300 to the mains power wiring in a building which is used to supply power to lighting module 300, form a power line network with system administrator 200 and supply power to lamp, luminaire or lighting element 314 functionally connected to lighting module 300. In one preferred embodiment, power line connection 312 may preferably incorporate a terminal block configured for wiring directly into the mains power of a building or structure. In one preferred embodiment, lighting module 300 may be mounted behind a wall or a wall mounted panel or integrated into a wall mounted light switch. If desired, lighting module 300 may be built into, or form part of, a lighting ballast mechanism, or be built into, or form part of, an LED luminaire. If desired, the ballast, lighting module and one or more LED lamps may preferably be built as a single device to form a complete LED luminaire. As used herein, the term “ballast” refers to a low voltage power supply commonly used in modern lighting systems, the construction and implementation of which are well established and known by those of ordinary skill in the art. By way of example only, ballast may be used to convert 240 volt mains power to a low voltage in order to run low voltage multifaceted reflector (MR) incandescent (including halogen) or LED lights. Where the lighting module forms part of a complete LED luminaire, power line connection 312 may conform to any common light connection standard such as, and by way of example only, an MR16, GU10, E26, E27, or PAR series of interface, allowing for engagement within a lighting fixture.

In one preferred embodiment, power line connection 312 may be configured for compatibility with the NEMA 5-15 North American mains power standard allowing lighting module 300 to plug directly into a mains power general purpose outlet. In another preferred embodiment, lighting module 300 may be configured with a flying lead. It will be appreciated that lighting module may be configured according to the plug and socket, and current and voltage requirements of various countries without departing from the scope of the present disclosure.

Data from power line communications controller 302 is physically modulated onto the mains wiring preferably through power line coupler 310 which preferably includes any necessary isolation or filters.

The commands and responses between system microcontroller 308 and the Product App running on smartphone 10 are communicated through a power line communications link supported by power line communications controller 302 in lighting module 300 and local network communications 206 in system administrator 200, and a wireless link with smartphone 10 supported by wireless communications 202 in system administrator 200.

Power line communications controller 302 preferably includes any combination of integrated circuits, components, controllers, digital signal processors, transceivers, memory, microprocessors, SiPs, or SoCs that allow system microcontroller 308 to communicate with system administrator 200 preferably through the mains power wiring of a building using a power line communication protocol, specification or standard. In one preferred embodiment, power line communications may be implemented using a single chip solution with integrated random access memory (RAM), physical layer (PHY), medium access controller (MAC), and analog front end. Power line communications controller 302 preferably supports one or more of: the HomePlug Powerline Appliance Homeplug standards or specifications including HomePlug Green PHY or HomePlug AV2; IEEE 1901, 1901.1, 1901.2 standards or specifications; or ITU-T's G.hn standards or specifications; including any amendments, extensions, subsets, revisions or proprietary implementations. Other suitable protocols, standards or specifications include, but are not limited to, those from the Universal Powerline Association, SiConnect, the HD-PLC Alliance, Xsilon, and the Powerline Intelligent Metering Evolution Alliance.

In one preferred embodiment, and not shown in FIG. 3, in addition to power line communications, power line communications controller 302 may preferably include any number and combination of integrated circuits, radios, aerials, memory, microcontrollers, SiPs, SoCs, transceivers, components or controllers to support wireless communication with a system administrator 200 and other lighting modules 300 via any suitable wireless PAN or HAN standard, protocol or specification including one or more of: any ZigBee protocol, specification, application profile or standard published by the ZigBee Alliance; any ANT protocol, specification or standard; any protocol, specification or standard published by the WI-SUN Alliance; any Z-Wave protocol, specification or standard; any Thread protocol, specification or standard published by the Thread Group Alliance; and/or any protocol, specification or standard based on IEEE 802.15 including, but not limited to, IEEE 802.15.4; including any amendments, extensions, subsets, revisions or proprietary implementations. Where power line communications controller 302 includes support for wireless communications, an additional aerial, or aerials, can be added as required. Where power line communications controller 302 includes support for both power line communications and a wireless mesh standard, system microcontroller 308 or a dedicated microcontroller in power line communications controller 302 may communicate using the power line network or wireless mesh network simultaneously, or dynamically assess the most robust communication channel with system administrator 200 and other lighting modules 300 and use the most robust communication medium in forming a communications link or transferring data down an open communication link.

Power conversion and control 306 preferably includes a physical output connection allowing a lamp, luminaire or lighting element 314 to be connected to, and powered from, lighting module 300. Power conversion and control 306 may be configured to operate and vary mains power level to lamps such as incandescent and high-intensity discharge lamps, or may be configured to control the power supplied to low voltage lamps, such as low voltage incandescent (including halogen) and LED lamps. In one preferred embodiment, power conversion and control 306 may conform to any common light connection standard such as, and by way of example only, the GU5.3 bi-pin standard or the GU10 turn-and-lock standard, thereby allowing a removable lamp to directly engage with power conversion and control 306. In one preferred embodiment, a lamp, luminaire or light emitting element may be permanently coupled to power conversion and control 306. Lighting module 300 may be designed to power more than one lamp, luminaire or lighting element.

In one preferred embodiment, power conversion and control 306 may include a single semiconductor switch, relay, or electro-mechanical relay configured to vary the supply of power to a lamp, luminaire or lighting element in a simple on/off fashion. In another preferred embodiment, power conversion and control 306 may include a number of relays configured to vary the supply of power to different lamps, luminaires or lighting elements separately, or grouped, in a simple on/off fashion. In another preferred embodiment, power conversion and control 306 may include any number and mix of semiconductor controllers, switches, mixers, relays, or electro-mechanical relays configured to vary the supply of power to individual components in a lighting element, or to various lamps or luminaires.

In another preferred embodiment, power conversion and control 306 may include a dimming control or controls. A dimming control is used to vary the amount of power transferred to a lamp, luminaire or lighting element where they have the appropriate characteristics to allow the light output to be varied anywhere from fully on to fully off, or some intermediate range of light output, as directed by system microcontroller 308. Using dimming in power conversion and control 306 under the control of system microcontroller 308, the amount of electrical power transferred to a lamp, luminaire or lighting element can be regulated. Because the electrical load presented to the dimming control can be resistive, inductive or capacitive depending on the light type and arrangement, the dimming unit can be configured to provide leading edge, trailing edge, pulse width modulation or other suitable methods of variable power control. Other requirements and methods to these basic dimming techniques would be understood by those of ordinary skill in the art of lighting control systems and will not be described in detail, however any methodology may be used where it has the same effect in being able to control the amount of light being emitted by a lamp, luminaire or lighting element.

The functional characteristics of different lamp technologies are such that some perform better using leading edge dimming while others perform better using trailing edge diming, or adaptations or variations thereof. Where lighting module 300 is not configured with a lamp, luminaire or light emitting element permanently coupled to power conversion and control 306, the user via the Product App is preferably able to specify the type of lamp or lighting element connected to lighting module 300. The Product App preferably configures the optimal dimming method for the type of lamp or lighting element chosen and commands lighting module 300 to use this method when dimming a connected lamp or lighting element. By way of example, if the lamp, luminaire or lighting element 314 is a low voltage halogen, dimming could be executed by system microcontroller 308 and power conversion and control 306 varying the average voltage applied across the lamp or lighting element by simulating the leading edge dimmer function used for mains power dimming of incandescent lamps while ensuring the maximum voltage rating of the lamp or lighting element is not exceeded. If the lamp, luminaire or lighting element 314 is a low voltage LED, dimming could be executed by system microcontroller 308 and power conversion and control 306 varying the average current passing through the lamp or lighting element by pulse width modulation methods while ensuring the maximum current rating of the lamp or lighting element is not exceeded. To ensure that lamp or lighting elements are protected, extensive monitoring and control of the voltage applied to and current drawn by the lamp, luminaire or lighting element is preferably performed by power conversion and control 306.

As the Product App is part of a network formed by smartphone 10, system administrator 200 and lighting module 300, persons of ordinary skill in the art of network and control will understand that the dimming control methods and parameters can be held in the Product App, system administrator 200 and/or in lighting module 300 without departing from the scope of the present disclosure.

Where lamp, luminaire or lighting element 314 is comprised of an array of segmented light emitting technologies, it may be preferable for the intensity of light from the segmented light emitting technologies to be separately and individually controlled by system microcontroller 308 and power conversion and control circuits 306.

In one preferred embodiment, lamp, luminaire or lighting element 314 may include a lighting array of coloured light emitting diodes (LED) capable of generating a spectrum of different colours through a process of colour mixing. Colour mixing typically involves generating a specific colour through varying the intensity or light output of a combination of red, green and blue LEDs. While one or more embodiments of the disclosure may be configured with the ability to use an array of coloured LEDs, it is not specifically limited to the use of red, green and blue LEDs, and may use any mixture of white and/or coloured light emitting technologies in order to achieve the desired colour mixing and spectrum capabilities.

In order for a user to choose or vary a colour, the Product App preferably provides a visual interface that represents an approximation of the spectrum of colours the lighting array is able to generate. Where user selects a colour in the Product App, the Product App preferably calculates the intensity of the component colours in the lighting array needed to deliver an approximation of the users chosen colour at the current brightness level. The Product App preferably commands system microcontroller 308 to vary power conversion and control circuits 306 to supply the necessary power to each component colour in the lighting array in order to generate a lighting colour closest representing the approximation chosen by the user in the Product App.

In one preferred embodiment, calculation of component colour mixing may preferably be handled by system microcontroller 208, system microcontroller 308, or a dedicated mixing component in lighting module 300 rather than the Product App.

In one preferred embodiment, lighting module 300 may support an external human interface 316 (FIG. 3) that could allow for the direct control of lighting module 300 without the use of a smartphone. This could allow a user, by way of example only, to turn a lamp, luminaire or lighting element on or off, or vary a dimming level, or change colour without the use of a smartphone.

It will be appreciated that the physical interconnection methods between the mains power wiring, lighting module and lamp, luminaire or lighting element may be performed by a range of permanent and/or different plug and receptacle connection types without departing from the scope of the present disclosure.

While not shown, in one preferred embodiment it may be desirable for lighting module 300 to include a power measurement capability allowing the electrical parameters of the electricity transferred through power conversion and control 306 to be measured and reported to system administrator 200 through system microcontroller 308. These parameters may include instantaneous voltage, current and power, Irms and Vrms, average real and apparent power and energy-to-pulse conversion. Some or all of the measured electrical parameters could be sent to smartphone 10 via the wireless communications link with system administrator 200 where the Product App would be able to perform additional calculations or conversions if required and display the results in a graphical format on the smartphone's touch sensitive screen for the user to view. Suitable processing of these parameters allows information such as the instantaneous power being used by a lamp, luminaire or lighting element 314 to be displayed. Power usage over time, total power used and trend analysis are also some of the useful representations of the basic electrical data that are preferably measured and could be displayed to the user. By using the smartphone's Internet capability, the Product App could access a power company's rates and charges, and provide the user with usage and cost comparisons.

The inclusion of power measurement allows more advanced functionality other than simple metering to be offered by lighting module 300. In one preferred embodiment, system microcontroller 308 may continuously measure various electrical parameters through a power measurement circuit allowing system microcontroller 308 to detect possible error conditions in order to cause power conversion and control 306 to reduce or cut power to a lamp, luminaire or lighting element 314 to protect both lighting module 300 and the lamp, luminaire or lighting element. In another preferred embodiment, system microcontroller 308 through a power measurement circuit may take a measurement of power conversion and control 306 under operational load to establish a normal operating threshold. System microcontroller 308 could periodically or continuously monitor the power measurement circuit and report to the Product App any deviation from the operating threshold. By way of example only, this could be used to measure the operating load of a group of lights connected to power conversion and control 306 and allow a user through the Product App to determine if any lights had failed based on the change in power being consumed rather than having to inspect each luminaire. In one preferred embodiment, any power measurement data generated by lighting module 300 may be transmitted to system administrator 200 allowing system microcontroller 208 to cause system microcontroller 308 to perform a function based on the power measurement data reported.

Perpetual clock calendar 304 preferably includes a power backup by the way of a battery or supercapacitor enabling real time to be accurately maintained in instances where power is lost. Inclusion of a perpetual clock calendar 304 allows system microcontroller 308 to automatically generate commands, perform any of its functions, or exchange data based on schedules or a function of time and/or date. In that way lighting module 300 could independently perform a number of complex, programmed automation schemes.

FIG. 4 is a pictorial representation of system 100 showing an exemplary arrangement of smart phone 10, system administrator 200 and multiple lighting modules 300a, 300b, and 300c, and the communications systems connecting each of the elements. Wi-Fi WLAN has an access point 14. Access point 14 has Internet connection 16. Wi-Fi WLAN communications preferably pass through access point 14. Where system administrator 200 is configured as a network Wi-Fi device, it will preferably operate as a client of access point 14. For smartphone 10 to communicate with system administrator 200 running as a network Wi-Fi device, smartphone 10 is also preferably connected to access point 14 as a client. Messages from smartphone 10 could then pass through access point 14 to system administrator 200 and vice-versa. If smartphone 10 were not in wireless range of access point 14, it may still be able to communicate through access point 14 to system administrator 200 via internet connection 16 if so configured. In one preferred embodiment, the Product App may preferably be able to use a smartphone's cellular or network Wi-Fi capabilities to exchange data with an external service provider in order to facilitate the remote control or interrogation of system administrator 200 through internet connection 16 and access point 14, where system administrator 200 operates as a network client of access point 14. The communications between a smartphone and an access point, and network clients of that access point, through an Internet connection would be well understood by those of ordinary skill in the art.

In addition to, or instead of, operating in network Wi-Fi mode, system administrator 200 may be configured to operate in a peer-to-peer mode preferably utilizing Wi-Fi Direct or operating as a SoftAP. In that instance, smartphone 10 can wirelessly connect directly to system administrator 200 directly without requiring any other device. Accordingly, it can be seen that: (1) access point 14 is not required for peer-to-peer communications; (2) the communications link is formed on an “as needed” basis; and (3) that smartphone 10 needs to be within radio range of system administrator 200 to establish a direct communications link. Where desirable, a peer-to-peer connection between smartphone 10 and system administrator 200 could be by way of Bluetooth.

It can be appreciated that a network Wi-Fi connection and a Wi-Fi Direct peer-to-peer connection offer a different mix of convenience and security. A system administrator operating as a network Wi-Fi device may be remotely controlled by a smartphone where access point 14 has an internet connection 16, however system administrator then becomes exposed to the outside world and may be vulnerable to external threats such as hacking. Alternatively, a Wi-Fi Direct connection by virtue of its limited wireless range and peer-to-peer architecture offers a higher level of security. The balance between operational modes is usually subjective and dependant on the application at hand. In some instances infrastructure limitations such as the availability of a WLAN may further constrain operational modes.

System administrator 200 may be configured to provide a received signal strength indicator, or received channel power indicator, of access point 14 which system administrator 200 may preferably report to the Product App for display on smartphone screen 12. A received signal strength indicator, or received channel power indicator, is a measurement of the power present in a received radio signal and allows a user to locate wireless products such as system administrator 200 close enough to access point 14 in order to ensure that a sufficiently strong wireless signal exists between the two devices to provide the best environment for a stable and reliable communications link. The Product App also preferably displays on smartphone screen 12 a received signal strength indicator, or received channel power indicator, for system administrator 200 measured by smartphone 10. The Product App may display on smartphone screen 12 a received signal strength indicator, or equivalent, of any lighting module 300 on the power line network measured by access administrator 200.

If desired, system administrator 200 may be configured with a visual indicator capable of displaying a received signal strength indication for any wired or wireless signal that system administrator 200 may be capable of measuring.

It can be appreciated that the adaptable nature of wireless communications 202 and its multi-mode, peer-to-peer and network communications capabilities allow a system administrator to be configured a number of different ways for communications with a smartphone with, or without, the use of a Wi-Fi network. By way of example, smartphone 10, power control unit 200 and the Product App may be configured to preferably utilize only those communication pathway(s) that allow for control of a system administrator without smartphone 10 having to disconnect a WLAN connection with access point 14. In that way, system administrator 200 may also be configured as a client of access point 14, however it may not always be possible or desirable to configure system administrator 200 as a client of access point 14. In that instance, communications between smartphone 10 and system administrator 200 would need to utilize a peer-to-peer communication standard supported by system administrator 200 and smartphone 10. Where smartphone 10 supports concurrent Wi-Fi Direct and network Wi-Fi, system administrator 200 and smartphone 10 could preferably form a Wi-Fi Direct communications link, allowing smartphone 10 to remain connected to access point 14 while concurrently connected peer-to-peer to system administrator 200. Where smartphone 10 does not support Wi-Fi Direct, system administrator 200 preferably appears as a Wi-Fi access point, however while it is not usually possible for a smartphone to connect to two access points at the same time, some smartphones are capable of connecting to an access point and a SoftAP or simulated access point at the same time so that smartphone 10 could remain connected to access point 14 and connect to system administrator 200 simulating a Wi-Fi access point or operating as a SoftAP. Where smartphone 10 cannot connect to access point 14 and a system administrator 200 simulating a Wi-Fi access point simultaneously, system administrator 200 may preferably be configured to communicate peer-to-peer with smartphone 10 using Bluetooth.

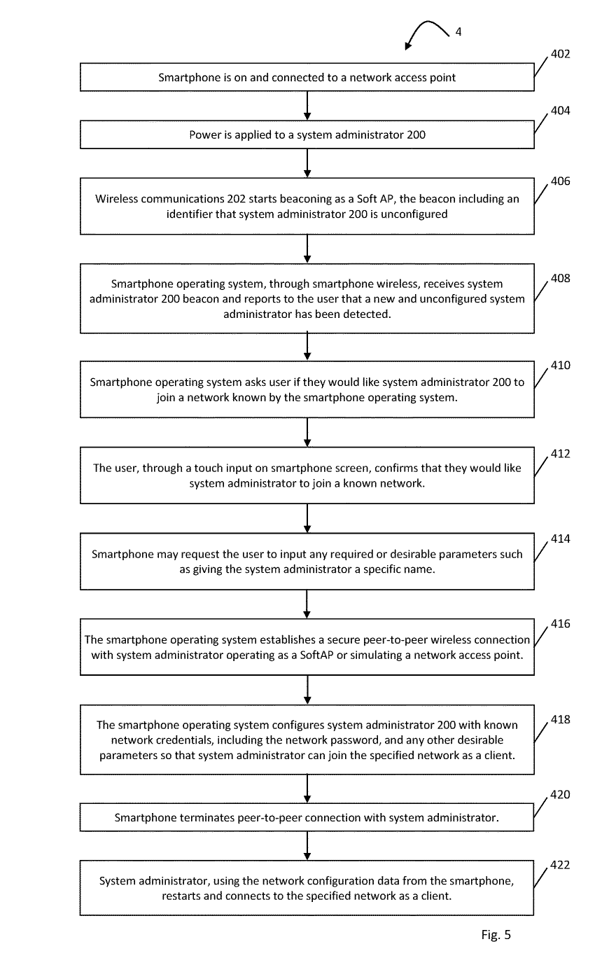

Turning now to FIG. 5, an exemplary configuration procedure 400 is shown for configuration of system administrator 200 as a network Wi-Fi device by smartphone 10 in a preferred embodiment of the present disclosure. While configuration procedure 400 has been described in relation to a smartphone operating system, configuration procedure 400 is not so limited and may be performed by the Product App where the Product App is able to control smartphone wireless communications as required.

At step 402, smartphone 10 is connected to a network access point, such as Wi-Fi network access point 14 in FIG. 4. At step 404 power is applied to system administrator 200 for the first time, allowing system administrator 200 to run all of its systems. At step 406, wireless communications module 202, configured to simulate a Wi-Fi network access point or operate as a SoftAP, begins to wirelessly beacon its network information. The wireless beacon preferably includes an identifier that reports system administrator 200 as an unconfigured Wi-Fi network device to Wi-Fi devices configured to interpret the identifier. At step 408, the smartphone operating system through the smartphone's wireless transceiver, receives the beacon of system administrator 200, determines from the identifier in the beacon that system administrator 200 is an unconfigured system administrator and reports to the user via the smartphone touch screen that it has detected a new and unconfigured system administrator. At step 410, the smartphone operating system asks the user if they would like system administrator 200 to join a known Wi-Fi network, preferably the network smartphone 10 is currently connected to. At step 412, the user through a touch input on the smartphone screen confirms they would like the unconfigured system administrator to join a network known by the smartphone operating system.

At step 414, smartphone operating system may require the user to enter a desirable or required parameter, such as a security code used in establishing a communications link between smartphone 10 and system microcontroller 208, or giving unconfigured system administrator 200 a specific name to be used during configuration as a network client. It can be appreciated that step 414 may be excluded where providing the quickest and easiest mechanism for configuration of a system administrator 200 by smartphone 10 as a network client of a network known by smartphone 10 is desirable, or where elements of step 414 may be performed after system administrator 200 is configured and connected to a network as a client, such as giving system administrator 200 a unique name.

At step 416, the smartphone operating system establishes a secure peer-to-peer Wi-Fi connection with system administrator 200 preferably configured to simulate a network access point or operate as a SoftAP. The opening of a secure peer-to-peer Wi-Fi connection may include the utilization of authentication hardware, firmware or software integrated into system administrator 200 and smartphone 10, so that system administrator 200 may automatically establish a secure connection with smartphone 10 utilizing an authentication handshake without requiring the user to input any security credentials manually. It can be appreciated that where smartphone 10 is unable to support a simultaneous connection with a network access point and a device simulating a Wi-Fi network access point or operating as a SoftAP, such as system administrator 200, smartphone 10 may be programmed to give preference to connecting with system administrator 200 by disconnecting from the Wi-Fi network access point in order to establish a secure peer-to-peer Wi-Fi connection with system administrator 200.

At step 418, the smartphone operating system configures system administrator 200 with the network credentials of a known network, including the network password, and any other desirable or necessary parameters so that system administrator 200 can join the specified network as a network Wi-Fi client device. At step 420, the smartphone operating system terminates the peer-to-peer Wi-Fi connection with system administrator 200. If the smartphone operating system disconnected from a network access point in order to establish a peer-to-peer Wi-Fi connection with system administrator 200 at step 416, the smartphone operating system preferably re-establishes a connection with the network access point. At step 422, system administrator 200, using the network configuration data from the smartphone operating system, configures itself according to the network parameters supplied as a network Wi-Fi device and connects to the specified network access point as a client, after which system administrator 200 and smartphone 10 are preferably able to communicate with each other through the network access point.

In one preferred embodiment, it may be preferable for system administrator 200 and smartphone 10 to utilize Wi-Fi Direct in establishing a peer-to-peer connection in configuration procedure 400.

It will be appreciated that certain steps outlined in configuration procedure 400 may be modified, deleted or added without departing from the scope of the present disclosure. For example, configuration procedure 400 may be adapted for execution by the Product App rather than a smartphone operating system. By way of another example, the smartphone operating system may cause system administrator 200 to start its configuration procedure after confirmation by the system administrator that it has successfully received the network parameters from the smartphone, or system microcontroller 208 of system administrator 200 may terminate the peer-to-peer connection with the smartphone and start its configuration procedure after successfully receiving network parameters from the smartphone without the smartphone operating system needing to initialize the process.

Referring again to FIG. 4, system administrator 200 preferably derives its power and communicates with lighting modules 300 through mains power lines using power line communications. It can be appreciated that power line communications allow for the convenient placement of system administrator 200 anywhere within a building's mains power architecture.

System administrator 200 preferably communicates with lighting modules 300a, 300b, and 300c via a power line network. Power line networking allows communications between system administrator 200 and any lighting module to be routed throughout the power cabling in a building passing through intermediate stations on the way to the recipient station. Because the network is formed by physical wiring, the communication path is not along a single point to point cable as in many typical wired network structures. Messages are broadcast onto the power lines and travel along all branches of the power line to their intended recipient. Where supported by the chosen power line communications protocol, specification or standard, each lighting module or station may preferably operate as a repeater of a broadcast signal. By way of example only, system administrator 200 wishing to send command data to lighting module 300b broadcasts that command onto the power lines in a building, the command propagating throughout the power system and potentially passing through other lighting modules operating as repeaters before reaching the intended lighting module 300b recipient. Individual lighting modules are identified through a unique address such as a unique MAC identification assigned by the system administrator at the time of authoring the lighting module onto system administrator's secure power line network.

It can be appreciated that power line communications offer a very powerful means for controlling devices over a wide physical area. Because smartphones do not include native power line communication capabilities, they cannot communicate directly with a lighting module 300. System administrator 200 preferably performs any computational tasks necessary to ensure data from the Product App is transposed and communicated in a format compatible with lighting module 300, and data from lighting module 300 is transposed and communicated in a format compatible with the Product App, thereby facilitating two way communications between the Product App and lighting module 300 across wireless and physical mediums such as shown in FIG. 4.

In order for the Product App running on smartphone 10 and lighting module 300 to communicate, any data preferably passes between system administrator 200 and smartphone 10 wirelessly either peer-to-peer or via WLAN, depending on the chosen configuration of access administrator 200. Any data passing between system administrator 200 and lighting module 300 preferably does so over a building's mains power wiring using power line communications.

The Product App running on smartphone 10 preferably allows lighting modules to be named and grouped for convenience in the Product App, preferably allowing a single command from the Product App to control a designated group of lighting modules simultaneously. By way of example only, a user may create a group called “Lounge Room” from four lighting modules installed in a lounge room of a typical house. The user may through the Product App choose to turn off the Lounge Room group of lights, the Product App preferably sending commands to the designated group of four lighting modules to execute the chosen off command. Persons of ordinary skill in the art of network and control will understand that grouping methods and parameters can be stored in the Product App, system administrator 200 and/or lighting module 300 without departing from the scope of the present disclosure.

It is contemplated and within the scope of the disclosure that additional lighting modules may be added to the overall system as desired. In one preferred embodiment, system administrator 200 may be configured with a means of powering the lighting module ensuring a close proximity of devices for the purpose of authoring. After a lighting module has been authored, all of the parameters for the system administrator's network will be stored in lighting module's non-volatile memory. The lighting module can then be unplugged from the system administrator and physically installed at its required location. When powered up again, the lighting module with join the system administrator's network using the parameters saved in its non-volatile memory.

If in future smartphones include ZigBee wireless communications capabilities, a smartphone 10 may preferably communicate with system administrator 200 using ZigBee where both devices are so configured.

Where system administrator 200 is equipped with ZigBee communication capabilities, it may preferably utilize the necessary ZigBee protocols and standards allowing it to communicate with lighting modules or other lighting technologies that are equipped solely with ZigBee communication capabilities as described in more detail in U.S. Application No. 61/786,519, filed Mar. 15, 2013.

It will be appreciated that the steps described above may be performed in a different order, varied, or certain steps added or omitted entirely without departing from the scope of the present disclosure. It will also be appreciated by those of ordinary skill in the art that the system described above can be varied in many ways without departing from the scope of the present disclosure.

1. A system for controlling a light in a residential or commercial location through a wireless communications link with a personal controller, the personal controller having a processor, a user interface, and a wireless communications transceiver, said system comprising:
at least one lighting module, said lighting module including a microcontroller, a power line communications controller, and a power line connection operably connected to said power line communications controller, said lighting module being configured to vary power to a light connected to said lighting module; and
a system administrator device including a microcontroller, a wireless communications module operable for wireless communication with the personal controller, and a local communications module configured for power line communications with said power line communications controller of said lighting module, said wireless communications module including circuitry configured to communicate with the personal controller using a peer-to-peer communications link.

2-9. (canceled)

10. The system of claim 1, wherein said wireless communications module of said system administrator device includes a first radio configured to provide a network Wi-Fi connection and a Wi-Fi peer-to-peer connection, and a second radio configured to provide a Bluetooth connection.

11. The system of claim 1, wherein said local communications module of said system administrator device includes a power line connection configured for power line communication with said lighting module, and a radio configured for wireless communication with said lighting module.

12-13. (canceled)

14. The system of claim 1, wherein said system administrator device is configured to plug into an electrical power source.

15-17. (canceled)

18. The system of claim 1, wherein said system administrator device is integrated into the wiring of a structure or building.

19. (canceled)

20. The system of claim 1, wherein said circuitry of said wireless communications module of said system administrator device is configured to communicate with the personal controller using Wi-Fi Direct.

21. The system of claim 1, wherein said circuitry of said wireless communications module of said system administrator device is configured to communicate with the personal controller using Bluetooth.

22. The system of claim 1, wherein said microcontroller of said wireless communications module of said system administrator device is configured to operate said wireless module of said system administrator device in more than one mode, said microcontroller being configured to operate said wireless communications module in a first mode using the peer-to-peer communications link, said microcontroller being configured to operate said wireless module in a second mode using a non-peer-to-peer communications link.

23. (canceled)

24. The system of claim 22, wherein said microcontroller of said wireless communications module of said system administrator device is configured to function as a network client device while operating in the second mode.

25. The system of claim 1, wherein said wireless communications module of said system administrator device is configured to open a peer-to-peer wireless communications link with the personal controller by operating as a SoftAP.

26-28. (canceled)

29. The system of claim 1, wherein microcontroller of said system administrator device is configured to command, independently of the personal controller, said lighting module.

30. The system of claim 29, wherein said microcontroller of said system administrator device is configured to concurrently command, independently of the personal controller, a plurality of said lighting modules.

31. The system of claim 29, wherein said microcontroller of said system administrator device is configured to individually command, independently of the personal controller, a plurality of said lighting modules.

32. A method for controlling, with a personal controller, lighting at a residential or commercial location, the method comprising:
receiving, at a system administrator device at or near a lighting location, a command from the personal controller to vary power to at least one specified light at the lighting location, the command being received by the system administrator device using a peer-to-peer wireless communications standard;
sending a command, with the system administrator device, to at least one lighting module connected to the specified light to vary the power to the specified light, the command being sent by the system administrator device using a power line communications standard; and
varying the power to the specified light, with the lighting module, in accordance with the command received from the system administrator device.

33-42. (canceled)

43. The method of claim 32, further comprising opening a peer-to-peer wireless communications link between the system administrator device and the personal controller, including assigning a simulated Wi-Fi access point role to the system administrator device.

44. The method of claim 32, further comprising establishing a Bluetooth communication link between the personal controller and the system administrator device to configure the system administrator device as a network Wi-Fi device and/or Wi-Fi Direct access point/group participant.

45. The method of claim 32, wherein the receiving of the command using the peer-to-peer wireless communications standard represents a first mode of communication, further comprising:
receiving an instruction at the system administrator device to either:
maintain the first mode of communication between the system administrator device and the personal controller; or
change to a second mode of communication between the system administrator device and the personal controller utilizing a non-peer-to-peer communications link.

46-47. (canceled)

48. The method of claim 32, wherein the command sent by the system administrator device is sent independently of the personal controller.

49. The method of claim 32, wherein the command sent by the system administrator device is sent concurrently to a plurality of the lighting modules.

50. The method of claim 32, wherein the command sent by the system administrator device is sent to a selected individual one of a plurality of the lighting modules.

51. The method of claim 32, further comprising determining, between a power line communications channel and a wireless communications channel operable by the system administrator device, which communications channel is more robust for communication between the system administrator device and the at least one lighting module.
